(19) United States
(12) Patent Application Publication
(10) Pub. No.: US 2024/0320034 A1
(43) Pub. Date: Sep. 26, 2024

(54) REDUCING VOLTAGE DROOP BY LIMITING ASSIGNMENT OF WORK BLOCKS TO COMPUTE CIRCUITS

(71) Applicants: Advanced Micro Devices, Inc., Santa Clara, CA (US); ATI Technologies ULC, Markham (CA)

(72) Inventors: Josip Popovic, Markham (CA); Anshuman Mittal, Santa Clara, CA (US)

(21) Appl. No.: 18/189,995

(22) Filed: Mar. 24, 2023

(51) Int. Cl. G06F 9/48; G06F 9/50

(52) U.S. Cl. CPC G06F 9/4881; G06F 9/4893; G06F 9/5038

(57) ABSTRACT

An apparatus and method for efficiently managing voltage droop among replicated compute circuits of an integrated circuit. In various implementations, an integrated circuit includes multiple, replicated compute circuits, each including circuitry to process tasks grouped into a work block. When a scheduling window has begun, the scheduler determines a value for a threshold number of idle compute circuits that can be simultaneously activated based on one or more of a number of active compute circuits, an operating clock frequency, a measured operating temperature, a number of pending work blocks, and an application identifier. If the scheduler determines that there is a count of idle compute circuits that is equal to or greater than the threshold number of idle compute circuits, then the scheduler limits the number of idle compute circuits that can be activated at one time to the threshold number.

### BACKGROUND

### Description of the Relevant Art

A variety of computing devices utilize heterogeneous integration, which integrates multiple types of integrated circuits (ICs) for providing system functionality. The multiple functions include audio/video (A/V) data processing, other high data parallel applications for the medicine and business fields, processing instructions of a general-purpose instruction set architecture (ISA), digital, analog, mixed-signal and radio-frequency (RF) functions, and so forth. A variety of choices exist for system packaging to integrate the multiple types of ICs. In some computing devices, a system-on-a-chip (SOC) is used, whereas, in other computing devices, smaller and higher-yielding chips are packaged as large chips in multi-chip modules (MCMs). In yet other computing devices, three-dimensional integrated circuits (3D ICs) that utilize die-stacking technology as well as silicon interposers to vertically stack two or more semiconductor dies in a system-in-package (SiP).

Regardless of the choice for the system packaging, the voltage droop of modern ICs has become an increasing design issue with each generation of semiconductor chips. Voltage droop constraints are not only an issue for portable computers and mobile communication devices, but also for high-performance superscalar microprocessors, which include multiple processor cores, or cores, and multiple pipelines within a core. The geometric dimensions of devices and metal routes on each generation of cores are decreasing. Superscalar designs increase the density of integrated circuits on a die with multiple pipelines, larger caches, and more complex logic. Therefore, the number of nodes and buses that switch per clock cycle significantly increases.

Parasitic inductance increases transmission line effects on a chip such as ringing and reduced propagation delays. Also, a simultaneous switching of a wide bus causes a significant voltage drop if a supply pin served all of the line buffers on the bus. This voltage droop, AV, is proportional to the expression L di/dt, wherein L is the parasitic inductance and di/dt is the time rate of change of the current consumption. If a large number of nodes in addition to buses switched simultaneously, a significant voltage drop occurs. Now a node that holds a logic high value experiences a voltage droop that reduces its voltage value below a minimum threshold. For memories and latches without recovery circuitry, stored values are lost.

One manner to reduce voltage droop is to reduce the operational clock frequency of the integrated circuit. However, the performance reduces. In addition, although the node capacitance switching decreases for certain blocks and/or circuits in the semiconductor chip by disabling the clock to these areas with qualified enable signals during periods of non-use, during use of these circuits, simultaneous switching of numerous nodes and signal lines again occur and the voltage droop problem can still exist. Another manner to reduce the voltage droop is placing an external capacitor between the supply leads. This external capacitance creates a passive bypass that reduces the supply line oscillation due to external inductances. However, it does not significantly reduce the oscillation caused by internal inductances.

Yet another manner to reduce inductance effects includes placing an on-chip capacitor between the internal supply leads. The capacitor acts as a bypass in the same manner as an external capacitor. However, in order to be effective, the internal capacitor is very large, which requires a significant portion of the chip area. This manner is undesirable when minimization of the die area is needed.

In view of the above, methods and systems for efficiently managing voltage droop of an integrated circuit are desired.

### BRIEF DESCRIPTION OF THE DRAWINGS

FIG. 1 is a generalized block diagram of an apparatus that manages voltage droop among replicated compute circuits of an integrated circuit.

FIG. 2 is a generalized block diagram of a graph that illustrates voltage droops of a power supply reference level of an integrated circuit.

FIG. 3 is a generalized block diagram of a graph that illustrates the number of active compute circuits over time of an integrated circuit.

FIG. 4 is a generalized block diagram of a method for efficiently managing voltage droop of multiple compute circuits of an integrated circuit.

FIG. 5 is a generalized block diagram of computing system that efficiently manages voltage droop of multiple compute circuits of an integrated circuit.

FIG. 6 is a generalized block diagram of an integrated circuit that efficiently manages voltage droop of multiple compute circuits.

FIG. 7 is a generalized block diagram of a scheduler that manages voltage droop among replicated compute circuits of an integrated circuit.

FIG. 8 is a generalized block diagram of a system-in-package (SiP) that manages voltage droop of multiple compute circuits of an integrated circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods efficiently managing voltage droop of multiple compute circuits of an integrated circuit are contemplated. In various implementations, an integrated circuit includes multiple, replicated compute circuits, each including circuitry to process a work block. Tasks performed by the integrated circuit are grouped into work blocks, where a “work block” is a unit of work executed in an atomic manner. The granularity of a work block can include a single instruction of a computer program, multiple instructions, a wavefront that includes multiple work items to be executed concurrently on multiple lanes of execution of a compute circuit. The scheduler assigns work blocks to idle compute circuits, which are subsequently activated and process the assigned work blocks.

When a scheduling window has begun, the scheduler determines a value for a threshold number of idle compute circuits that can be permitted to be simultaneously activated. In some implementations, the scheduler determines the value for this threshold number based on one or more of a number of active compute circuits, a total number of compute circuits, a number of stalled compute circuits, a number of compute circuits that have recently completed executing work blocks, an operating clock frequency, a measured operating temperature, a number of pending work blocks, any measured preexisting voltage droop, the queue utilization values of queues of the compute circuits that store assigned work blocks, and an application identifier specifying a type of application (and thus, the type of work block) being processed by a corresponding compute circuit. If the scheduler determines that there is a count of idle compute circuits that is equal to or greater than the threshold number of idle compute circuits, then the scheduler assigns a number of work blocks to idle compute circuits equal to the threshold number. In other words, the scheduler limits the number of idle compute circuits that can be activated at one time to the threshold number.

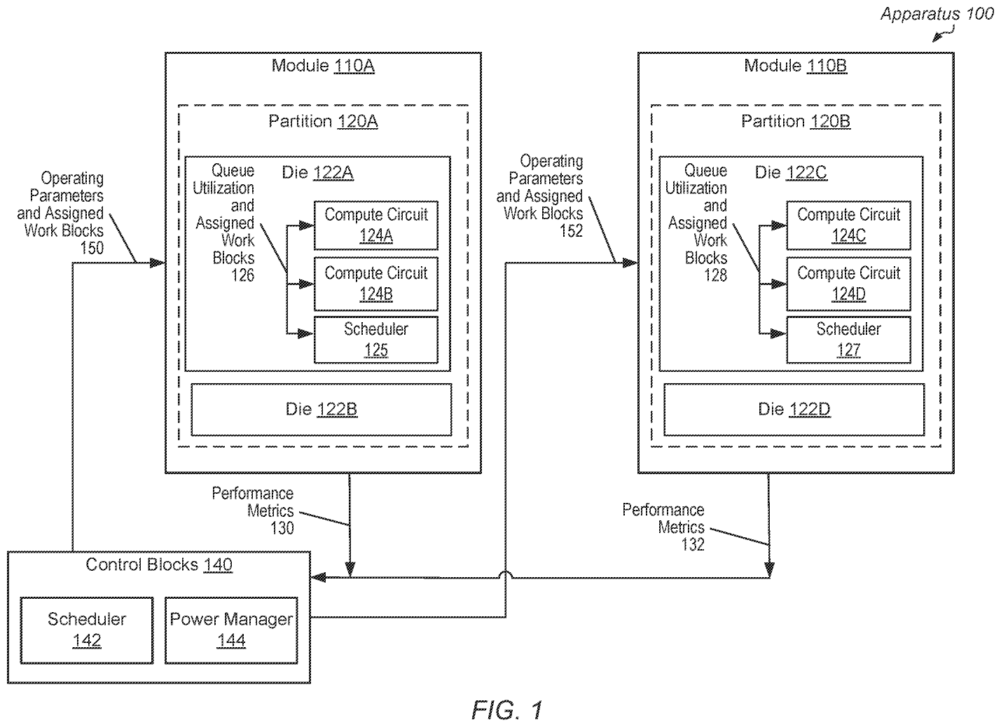

In some implementations, the scheduler changes the rate of scheduling. During a predetermined time period, the scheduler limits the total number of idle compute circuits that can be assigned work blocks and activated to process the assigned work blocks. In an implementation, the scheduler defines the time period as a particular number of clock cycles. At the end of the time period, such as an expiration of a period of time since a most recent scheduling window, the scheduler reevaluates scheduling based on updated parameters. Further details of these techniques to reduce the voltage droop of multiple compute circuits of an integrated circuit are provided in the following description of FIGS. 1-8.

Referring to FIG. 1, a generalized block diagram is shown of an apparatus 100 that manages voltage droop among replicated compute circuits of an integrated circuit. In the illustrated implementation, the apparatus 100 includes the control blocks 140 and at least two modules, such as modules 110A-110B, which include circuitry configured to perform (or “execute”) tasks (e.g., based on execution of instructions, detection of signals, movement of data, generation of signals and/or data, and so on). The tasks are grouped into work blocks. As used herein, a “work block” is a unit of work executed in an atomic manner. In some implementations, the granularity of the work block includes a single instruction of a computer program. In other implementations, the granularity of the work block includes multiple work items to be executed concurrently on the hardware of multiple lanes of execution of a compute circuit. In such implementations, the work block can also be referred to as a “wavefront” which is further described shortly. The control blocks 140 includes the scheduler 142 and the power manager 144. The control blocks 140 send operating parameters and assigned tasks 150 to the module 110A. The control blocks 140 also sends operating parameters and assigned tasks 152 to the module 110B. The control blocks 140 receive the performance metrics 130 from module 110A and performance metrics 132 from module 110B.

The module 110A includes the partition 120A that includes the semiconductor dies 122A-122B (or dies 122A-122B). The module 110B includes the partition 120B that includes the dies 122C-122D. In some implementations, each of the dies 122A-122B and 122C-122D includes one or more compute circuits. For example, die 122A includes the compute circuits 124A and 124B (or compute circuits 124A-124B), and the die 122C includes the compute circuits 124C and 124D (or compute circuits 124C-124D). Although not shown, the dies 122B and 122D can also include one or more compute circuits. In various implementations, the hardware, such as circuitry, of each of the dies 122B and 122C-122D is an instantiated copy of the circuitry of the die 122A. Although only two modules 110A-110B are shown, and only two dies are shown within each of the partitions 120A-120B, other numbers of modules and compute circuits used by apparatus 100 are possible and contemplated and these numbers are based on design requirements.

Each of the modules 110A-110B is assigned a power domain by the power manager 144. In some implementations, each of the modules 110A-110B uses a respective power domain. In such implementations, the operating parameters of the information 150 and 152 are separate values. In other implementations, the modules 110A-110B share the same power domain. In such implementations, the operating parameters of the information 150 and 152 are the same values. Depending on the implementation, the power manager 144 selects a same or a respective power management state for each of the modules 110A-110B. As used herein, a “power management state” is one of multiple “P-states,” or one of multiple power-performance states that include a set of operational parameters such as an operational clock frequency and an operational power supply voltage.

Each of the power domains includes at least the operating parameters of the P-state such as at least an operating power supply voltage and an operating clock frequency. Each of the power domains also includes control signals for enabling and disabling connections to clock generating circuitry and a power supply reference. These control signals are also included in the information 150 and 152. In an implementation, an “active compute circuit” of the compute circuits 124A-124B and 124C-124D uses a non-zero value of an operational clock frequency and an operational power supply voltage for executing an assigned work block. An “idle compute circuit” of the compute circuits 124A-124B and 124C-124D has no assigned work block, and typically is clock gated, or otherwise, the idle compute circuit has connections to clock generating circuitry disabled. In some implementations, an idle compute circuit has connections to a power supply reference level (or power rail) disabled. For example, power switches are disabled, which disconnects the idle compute circuit from the power rail. In other implementations, an idle compute circuit is clock gated only, and the idle compute circuit maintains a connection to its power supply reference level.

In some implementations, the functionality of the apparatus 100 is included as one die of multiple dies on a system-on-a-chip (SOC). In other implementations, the functionality of the apparatus 100 is implemented by multiple, separate dies that have been fabricated on separate silicon wafers and placed in system packaging known as multi-chip modules (MCMs). Other components of the apparatus 100 are not shown for ease of illustration. For example, a memory controller, one or more input/output (I/O) interface circuits, interrupt controllers, one or more phased locked loops (PLLs) or other clock generating circuitry, one or more levels of a cache memory subsystem, and a variety of other compute circuits are not shown although they can be used by the apparatus 100. In various implementations, the apparatus 100 is used in a desktop, a portable computer, a mobile device, a server, a peripheral device, or other. The apparatus 100 is capable of communicating with an external general-purpose central processing unit (CPU) that includes circuitry for executing instructions according to a predefined general-purpose instruction set architecture (ISA). The apparatus 100 is also capable of communicating with a variety of other external circuitry such as one or more of a digital signal processor (DSP), a display controller, a variety of application specific integrated circuits (ASICs), a multimedia engine, and so forth.

As described earlier, the tasks performed by the apparatus 100 can be grouped into work blocks, where a “work block” is a unit of work executed in an atomic manner. The granularity of a work block can include a single instruction of a computer program, and this single instruction can also be divided into two or more micro-operations (micro-ops) by the apparatus 100. The granularity of a work block can also include one or more instructions of a subroutine. The granularity of a work block can also include a wavefront assigned to the circuitry of multiple lanes of execution of the compute circuits 124A-124B and 124C-124D when these compute circuits are implemented as single instruction multiple data (SIMD) circuits. In such an implementation, a particular combination of the same instruction and a particular data item of multiple data items is referred to as a “work item.” A work item is also referred to as a thread. In an implementation, each of the compute circuits 124A-124B and 124C-124D is a SIMD circuit that includes 64 lanes of execution. Therefore, each of the compute circuits 124A-124B and 124C-124D (or SIMD circuits) is able to simultaneously process 64 threads. In other implementations, the compute circuits 124A-124B and 124C-124D include another type of circuitry that provides another functionality when executing on another type of assigned work block.

In an implementation, the scheduler 142 receives work blocks to assign to the compute circuits 124A-124B and 124C-124D, and does so based on load balancing. In one implementation, the scheduler 142 is a command processor of a graphics processing unit (GPU), work blocks are wavefronts, and the scheduler 142 retrieves the wavefronts from a buffer such as system memory. Other circuitry, such as a general-purpose central processing unit (CPU), stores the wavefronts in the buffer and sends an indication to the apparatus 100 specifying that pending wavefronts are stored in the buffer. In other implementations, the scheduler 142 is included in another type of circuitry other than a GPU, and the scheduler 142 receives the work blocks from another type of circuitry other than a CPU.

In some implementations, the scheduler 142 assigns work blocks to the partitions 120A and 120B in a round-robin manner. Work blocks assigned to the compute circuits 124A-124B of the die 122A are received by the scheduler 125. Work blocks assigned to the compute circuits 124C-124D of the die 122C are received by the scheduler 127. The following discussion describes further scheduling steps such as assigning work blocks to the compute circuits 124A-124B and 124C-124D. Although the following discussion describes these further scheduling steps being performed by the schedulers 125 and 127, in other implementations, these schedulers 125 and 127 are absent, and the upcoming further scheduling steps are performed by the scheduler 142. In yet other implementations, these schedulers 125 and 127 are absent, and the upcoming further scheduling steps are performed by a scheduler (not shown) within the partitions 120A and 120B.

In an implementation, the operating parameters of the modules 110A and 110B can have values that vary from one another by more than a threshold. In one example, the modules 110A and 110B share one or more power rails that provide one or more power supply reference levels, but the module 110B can operate at a clock frequency that is one half or one quarter of the clock frequency used by the module 110A. It can be advantageous for the scheduler 142 to perform further scheduling steps that assign work blocks to the compute circuits 124A-124B and 124C-124D in a manner to reduce the voltage droop of one or more power rails used by the modules 110A-110B. However, in such implementations, the latency of communication between the scheduler 142 and the compute circuits 124A-124B and 124C-124D is below a threshold. For example, the compute circuits 124A-124B and 124C-124D are capable of sending the queue utilization values of the parameters 126 and 128 to the scheduler 142 with a latency below a threshold.

In other implementations, the operating parameters of the modules 110A and 110B have values that vary from one another by less than a threshold such that the separate schedulers 125 and 127 use scheduling windows that overlap one another. This overlap allows the schedulers 125 and 127 to assign work blocks to corresponding compute circuits of the compute circuits 124A-124B and 124C-124D in a manner to reduce the voltage droop of one or more power rails shared by the modules 110A-110B. In some implementations, the circuitry of the scheduler 125 assigns, for execution, the work blocks received from the scheduler 142 to the compute circuits 124A-124B of the die 122A. As shown, the scheduler 125 sends work blocks as part of the information 126 to the compute circuits 124A-124B of the die 122A. Similarly, the circuitry of the scheduler 127 assigns the received work blocks for execution to the compute circuits 124C-124D of the die 122C. As shown, the scheduler 127 sends work blocks as part of the information 128 to the compute circuits 124C-124D of the die 122C. In various implementations, the scheduler 125 and the scheduler 127 assign work blocks to corresponding compute circuits of the compute circuits 124A-124B and 124C-124D in a manner to reduce the voltage droop of one or more power rails used by the modules 110A-110B.

Each of the schedulers 125 and 127 is capable of determining a corresponding scheduling window has begun. The following discussion is directed to the scheduler 125. However, the scheduler 127 includes circuitry that performs similar steps. As described earlier, in other implementations, the scheduler 142 includes circuitry that performs the following steps, but concurrently uses the operating parameters of both the information 150 and 152 and the queue utilizations of both the information 126 and 128. To determine the scheduling window has begun, in an implementation, the scheduler 125 determines that a time period has elapsed since a most recent assignment of work blocks to the compute circuits 124A-124B of the die 122A has been performed. In response to determining the scheduling window has begun, the scheduler 125 determines a threshold number of idle compute circuits of the compute circuits 124A-124B that can be permitted to be simultaneously activated. An idle compute circuit is activated when connections to one or more of clock generating circuitry and a power rail are reenabled. In some implementations, the scheduler 125 determines this threshold number of idle compute circuits based on one or more of a number of active compute circuits, an operating clock frequency, a measured operating temperature, the queue utilizations (information 126) of queues of the compute circuits that store assigned work blocks, and an application identifier specifying a type of application (and thus, the type of work block) being processed by a corresponding compute circuit.

If the scheduler 125 determines that there is a count of idle compute circuits that is equal to or greater than the threshold number of idle compute circuits, then the scheduler 125 assigns a number of work blocks to idle compute circuits of the compute circuits 124A-124B equal to the threshold number. In other words, the scheduler 125 limits, to the threshold number, the number of idle compute circuits of the compute circuits 124A-124B that can be activated at one time. In an example, the apparatus 100 has 96 total compute circuits with 24 compute circuits in each of the dies 122A-122B and 122C-122D. The die 122A has 16 compute circuits being idle and 8 compute circuits being activated and already processing assigned work blocks. The circuitry of the scheduler 125 is able to simultaneously assign 8 compute circuits in a clock cycle, but the threshold number is 4 for this particular clock cycle (or this particular scheduling window). Therefore, the scheduler 125 assigns work blocks to only 4 idle compute circuits, rather than 8 idle compute circuits. This limit on the number of compute circuits to activate reduces voltage droop among the modules 110A-110B.

In some implementations, the scheduler 125 changes the rate of scheduling. During a predetermined time period, the scheduler 125 limits the total number of idle compute circuits that can be assigned work blocks and activated to process the assigned work blocks. In an implementation, the scheduler 125 defines the time period as a particular number of clock cycles. The scheduler 125 can determine to assign work blocks to idle compute circuits at a rate of 2 idle compute circuits every other clock cycle during the time period. At the end of the time period, the scheduler 125 reevaluates scheduling based on updated parameters. For example, the scheduler 125 redefines the threshold number of idle compute circuits based on updated values of one or more of the number of active compute circuits, the operating clock frequency, the measured operating temperature, the queue utilizations of the information 126, and any new application identifiers.

The queue utilizations of the information 126 include a number of available queue entries (or slots) in queues of the compute circuits 124A-124B. In an implementation, these queues of the compute circuits 124A-124B are implemented as first-in, first-out (FIFO) buffers. Each queue entry of the queue is capable of storing an assigned work block received from the scheduler 142. Each queue entry can also be referred to as a “slot.” A slot stores program state of the assigned work block. In various implementations, the compute circuits 124A-124B maintain a count of available slots, or queue entries, in the queues that store assigned work blocks. The compute circuits 124A-124B send this count as information 126 to the scheduler 125. In some implementations, when the scheduler 125 assigns a number of work blocks, such as 8 work blocks, in a first scheduling window, the compute circuits 124A-124B complete these 8 assigned work blocks prior to the start of a subsequent second scheduling window. However, in other implementations, it is possible that the compute circuits 124A-124B do not complete one or more of these 8 assigned work blocks prior to the start of the subsequent second scheduling window. In order not to schedule, in the subsequent second scheduling window, more work blocks that inadvertently exceeds the threshold number of idle compute circuits, the scheduler 125 uses the updated queue utilizations of the information 126 to perform scheduling.

When a corresponding compute circuit of the compute circuits 124A-124B begins to execute an assigned work block of one of its slots, the compute circuit uses the stored program state. In an implementation, the stored program state includes a program counter and a pointer to work items. The compute circuit uses the stored program state to fetch instructions and data of work items of the assigned work block, if the instructions and data of work items are not yet available in the instruction cache and data cache of the compute circuit. During cache misses of one or more of the instruction cache and the data cache, it is possible that the latency to service cache misses causes the assigned work block to remain in the slot when a next scheduling window begins. Thus, the works unis that had already been assigned have not yet completed execution. It is possible, depending on the latencies to service cache misses, that the works blocks that had already been assigned have not yet begun execution. The compute circuit sends an updated number of available slots (or other indication of queue utilization) as part of the information 126 to the scheduler 125. It is possible that the scheduler 125 assigned 8 work blocks to the compute circuit 124A, but by the time another scheduling window arrives, the compute circuit 124A completed only 6 of the 8 assigned work blocks, rather than completed all 8 assigned work blocks.

Without the above information, such as the updated number of available slots as part of the information 126, it is possible that the scheduler 125 assigns more work blocks in a subsequent scheduling window that inadvertently exceeds the threshold number of idle compute circuits. With the above information, in an implementation, the scheduler 125 does not further assign more work blocks until all of the previously assigned work blocks have completed. Therefore, the scheduler 125 assigns no work blocks for one or more subsequent scheduling windows. In another implementation, the scheduler 125 updates the threshold number of idle compute circuits for the subsequent scheduling window based on the received queue utilizations of the compute circuits 124A-124B provided in the information 126. Each of the queue utilizations (or queue utilization values) can be represented as one of a number of available (unoccupied or free) queue entries of a corresponding queue, a number of occupied (allocated with valid data) queue entries of the corresponding queue, a ratio of occupied queue entries to a total number of queue entries of the corresponding queue, a ratio of available queue entries to a total number of queue entries of the corresponding queue, or other.

In an implementation, the apparatus 100 has 64 total compute circuits with 16 compute circuits in each of the dies 122A-122B and 122C-122D. For a first scheduling window, each of the 16 compute circuits is idle and the scheduler 125 determines that the threshold number of idle compute circuits is 8. Although there are a sufficient number of work blocks to assign to all 16 compute circuits, the scheduler 125 assigns 8 work blocks to the die 122A, rather than 16 work blocks. This assignment of work blocks by the scheduler 125 reduces voltage droop of the modules 110A-110B that share power rails.

During a subsequent second scheduling window, the die 122A has 8 active compute circuits and 8 idle compute circuits. The scheduler 125 determines that the threshold number of idle compute circuits to assign work blocks (or threshold number of idle compute circuits) is 4. Therefore, the scheduler 125 assigns 4 work blocks to 4 compute circuits of the die 122A, rather than 8 work blocks to 8 compute circuits. This assignment of work blocks by the scheduler 125 reduces voltage droop of the modules 110A-110B that share power rails. During execution, though, two of these four compute circuits have execution of work blocks stalled due to one or more of instruction cache misses and data cache misses. Without the queue utilization of the information 126, during the next (third) scheduling window, using at least the ratio of 4 idle compute circuits to 16 total compute circuits, the scheduler 125 determines the updated threshold number of idle compute circuits is 2. However, after the instruction cache misses and/or data cache misses are serviced, the two previously stalled compute circuits can begin execution after the third scheduling window completes. Combining these two compute circuits (previously assigned during the second scheduling window) with the two compute circuits that now receive work blocks from the scheduler 125 during the third scheduling window, results in the number of compute circuits that can begin execution being 4. This number of 4 compute circuits that can begin execution after completion of the third scheduling window exceeds the updated threshold number of idle compute circuits of 2 for the third scheduling window.

To avoid the above scenario of exceeding the updated threshold number of idle compute circuits of 2 for the third scheduling window, the scheduler 125 uses the queue utilization of the information 126. With the queue utilization of the information 126, during the third scheduling window, the scheduler 125 is aware that two of the previously four compute circuits being assigned work blocks had execution of work blocks stalled, or otherwise, did not begin execution with the arithmetic logic units (ALUs) and other computational circuitry by the point in time that the third scheduling window began. Accordingly, the scheduler 125 determines the updated threshold number of idle compute circuits is 0, rather than 2. Therefore, after completion of the third scheduling, it is not possible for the number of compute circuits that can begin execution to exceed 2 compute circuits and drawing sufficient current to create voltage droop greater than a voltage threshold. It is possible that no compute circuits begin execution after the third scheduling window, since the two compute circuits (previously assigned during the second scheduling window) can continue to remain stalled, or otherwise, do not begin execution by the point in time that a subsequent fourth scheduling window begins.

Alternatively, in the third scheduling window, the scheduler 125 determines the updated threshold number of idle compute circuits based on additional information within the information 126 such as a number of compute circuits that have completed execution. In an implementation, during the third scheduling window, the scheduler 125 receives an indication from the information 126 that 3 of the previously assigned compute circuits (assigned during the first scheduling window) have completed their assigned work blocks, and these 3 compute circuits are returning to being idle. The scheduler 125 is also aware of the other 2 compute circuits (assigned during the second scheduling window) that have stalled, or otherwise, are simply performing memory accesses, but have not yet begun execution by ALUs by the point in time that the third scheduling window begins.

Accordingly, during this third scheduling window, the scheduler 125 determines a total number of idle compute circuits is a sum of the 4 idle compute circuits that have yet to be assigned work blocks, the 2 compute circuits that have stalled, and the 3 compute circuits that returned from being active to being idle. This total is 9 idle compute circuits. This total of 9 idle compute circuits is greater than a number of idle compute Circuits of 4 determined without consideration of the information 126 that includes indications of the 2 compute circuits that have stalled and the 3 compute circuits that returned from being active to being idle. Based on the total of 9 idle compute circuits, the scheduler 125 determines the threshold number of idle compute circuits is 5. This threshold number of idle compute circuits of 5 is larger than the number of 4 idle compute circuits determined without consideration of the information 126 and less than the number of 9 idle compute circuits determined from using the information 126. Using the information 126 to determine the threshold number of idle compute circuits for assigning work blocks allows the scheduler 125 to assign work blocks to the compute circuits in a manner that reduces voltage droop of the modules 110A-110B that share power rails.

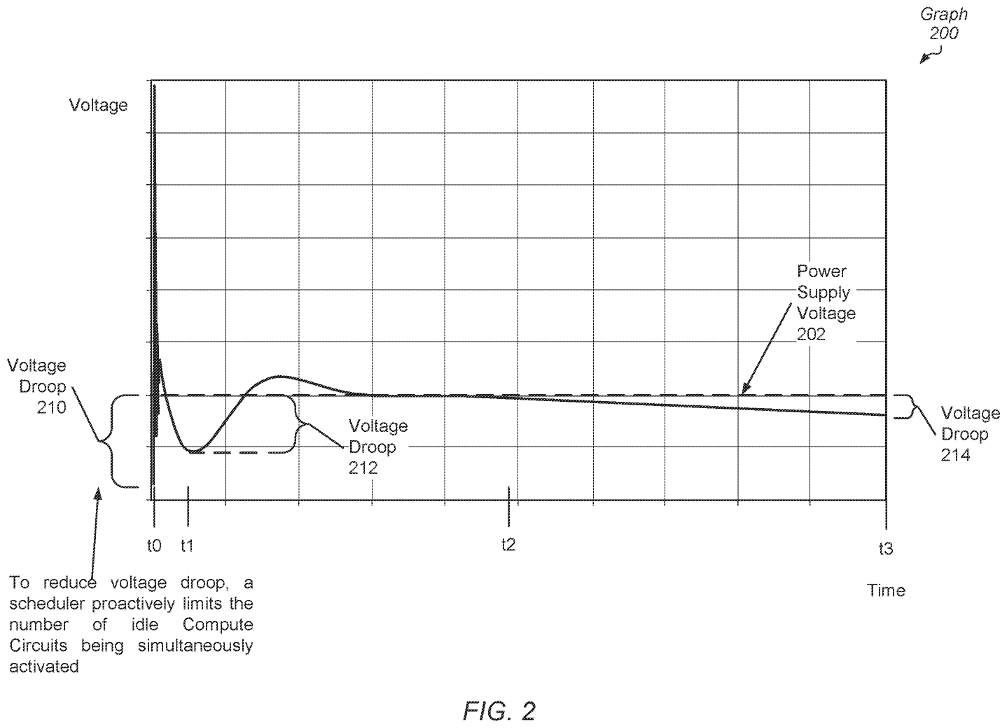

Referring to FIG. 2, a generalized block diagram is shown of a graph 200 that illustrates voltage droops of a power supply reference level of an integrated circuit. The graph 200 illustrates the power supply voltage 202 over time. The power supply voltage 202 is a power supply reference level on a power rail of an integrated circuit. During operation of the integrated circuit, three different voltage droops 210, 212 and 214 occur over time. The simultaneous switching of a wide bus can cause a significant voltage drop of the power supply voltage 202 when the corresponding power rail provides a large amount of current to circuitry, such as buffers of the wide bus, connected to the power rail. This voltage drop, which is also referred to as “voltage droop,” is expressed as AV, which is proportional to the expression L di/dt, where L is the parasitic inductance and di/dt is the time rate of change of the current consumption from the power rail. In addition to a wide bus, the near simultaneous switching of a large number of other nodes of the integrated circuit can also consume a large amount of current from the shared power rail. When this switching occurs, a significant voltage drop can occur for the power supply voltage 202.

As shown, a voltage droop 210 occurs at the point in time t0 (or time t0), a voltage droop 212 occurs at the time t1, the power supply voltage 202 begins to decline again at the time t2, and a voltage droop 214 occurs at the time t3. The voltage droop 210 at time t0 occurs when a large number of nodes simultaneously switch such as a significant number of idle compute circuits are simultaneously activated. In an implementation, the power supply voltage 202 is 900 millivolts (mV) and the voltage droop 210 is 300 mV. A node that previously stored a Boolean logic high value can be significantly reduced such that the node voltage appears as a Boolean logic low value to circuitry. Node voltage glitches and even data loss can occur.

Once the multiple idle compute circuits are activated, the power supply voltage 202 can temporarily returns to its original value. However, the voltage droop 212 occurs at time t1 and the voltage droop 214 occurs at time t3 due the simultaneous switching of some wide buses and nodes as applications are processed by the multiple active compute circuits. These voltage droops 212 and 214 are not as large as the voltage droop 210. External capacitors are placed between the power rails to create a passive bypass that reduces the power rail oscillation due to external inductances. On-die capacitors are placed between power rails on the semiconductor die to reduce internal inductance effects. These on-die capacitors are typically large to be effective, which consumes on-die area.

The compute circuits also include circuitry that perform reactive solutions to voltage droop such as detecting and reducing the time rate of change of current consumption, di/dt. In some implementations, these reactive solutions include one or more of temperature sensors and current consumption measuring sensors. In order to be beneficial and to prevent a voltage droop from lowering a node voltage below a minimum threshold, these reactive solutions have the requirement of initiating a current reduction within a predetermined time window. These capacitor and reactive circuitry solutions are unable to be greatly effective against the voltage droop 210 due to the quick, initial occurrence when multiple idle compute circuits are activated. To reduce the voltage droop 210, a scheduler proactively limits the number of idle compute circuits being permitted to be simultaneously activated.

In some implementations, when the scheduler proactively limits the number of idle compute circuits permitted to be simultaneously activated, the scheduler additionally uses the output measurements of temperature sensors and any voltage droop measurement circuits. These circuits can provide a non-zero voltage droop measurement. In an implementation, this type of information is included in the information 126 (of FIG. 1) to provide an indication of any initial, or preexisting, voltage droop prior to and at time t0 in the graph 200. For example, the integrated circuit has been executing applications for a duration, and although prior to time t0, no work blocks of a next iteration of subroutines have yet to be assigned, due to the present operating temperature and non-zero preexisting voltage droop, the power supply voltage 202 is already less than its expected value. This smaller power supply voltage value prior to and at time t0 is used by the scheduler when determining the threshold number of idle compute circuits and assigning work blocks to compute circuits.

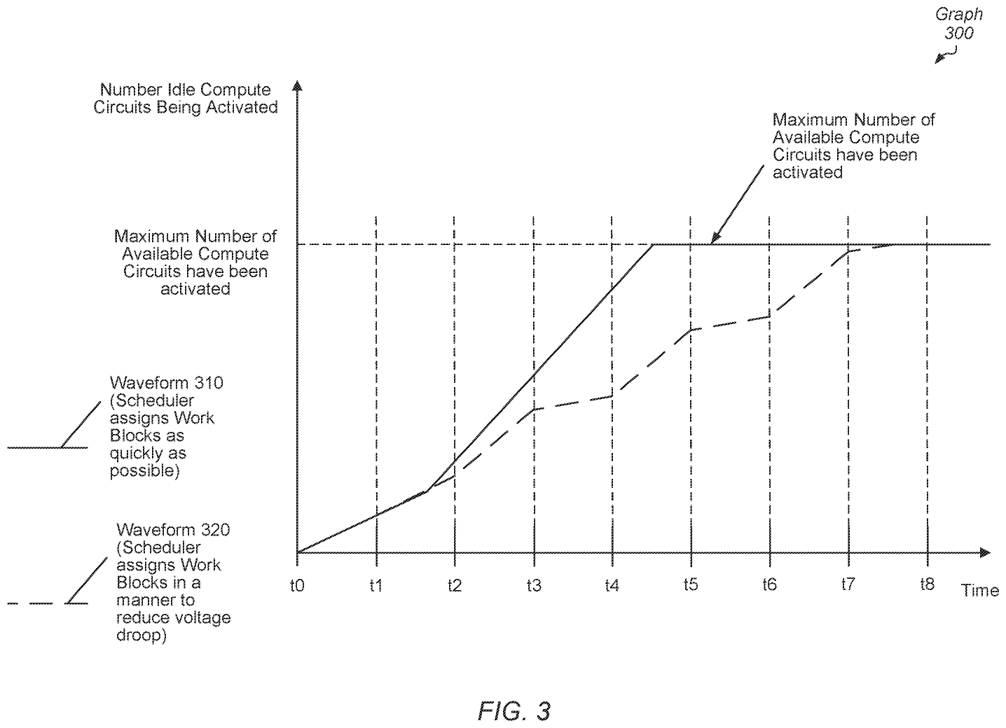

Turning now to FIG. 3, a generalized block diagram is shown of a graph 300 that illustrates the number of active compute circuits over time of an integrated circuit. The graph 300 illustrates the number of compute circuits activated over time. This number is also equal to the number of work blocks currently being executed, since each activated compute circuit receives a work block. In some implementations, the compute circuit is a SIMD circuit with multiple lanes of execution of the integrated circuit and the work block is a wavefront (or wave) that includes multiple work items. The graph 300 includes the waveforms 310 ad 320. The waveform 310 illustrates the number of active compute circuits when the scheduler assigns work blocks to available compute circuits as quickly as possible. The waveform 320 illustrates the number of active compute circuits when the scheduler assigns work blocks in a manner to reduce voltage droop.

In the implementation shown, for the duration of time from time t0 to time t8, no compute circuits that have been activated complete a work block and return to an idle state. However, during other durations of time, such an event occurs. At time t0, no compute circuits have yet been activated. Therefore, both waveforms 310 and 320 indicate zero compute circuits are active. Between times t0 and t1, work blocks of an application that has begun to run are being retrieved and/or built by external circuitry. The work blocks are sent to the scheduler. In some implementations, regardless of the scheduling algorithm implemented by circuitry of the scheduler, the rate of assigning work blocks and activating compute circuits is the same due to the initial rate of receiving work blocks at the onset of executing the application. In other implementations, the rates are different already.

In various implementations, the scheduling algorithm corresponding to the waveform 320 updates a rate of assigning work blocks and activating compute circuits at particular time intervals. This time interval is shown between each of the marked times such as at time t1, time t2, time t3, and so on. This time interval can include a number of clock cycles based on a currently used operating clock frequency. Between the times t1 and t2, the waveform 310 indicates an increase in the rate of assigning work blocks and activating compute circuits. The waveform 310 indicates this same higher rate is used without interruption until the maximum number of available compute circuits have been activated between times t4 and t5.

In contrast to the waveform 310, the waveform 320 indicates between the times t1 and t2 a continuation of the same rate used between times t0 and t1. At times t0 and t1, the scheduler corresponding to the waveform 320 has determined that a count of pending work blocks to assign is less than a threshold number of idle compute circuits that can be permitted to be simultaneously activated. Again, if the number of work blocks initially sent to the scheduler is already high, then it is possible that the count of pending work blocks to assign is equal to or greater than the threshold number of idle compute circuits, and the rate indicated by the waveform 320 decreases. At time t2, the waveform 320 indicates an increase in the rate of assigning work blocks and activating compute circuits than the rate used between times t0 and t2. At time t2, again, the scheduler corresponding to the waveform 320 has determined that a count of pending work blocks to assign is less than a threshold number of idle compute circuits that can be simultaneously activated. However, the number of pending work blocks has increased, so the rate indicated by the waveform 320 has increased.

At time t3, the waveform 320 indicates a decrease in the rate of assigning work blocks and activating compute circuits than the rates used beforehand. Here, the corresponding scheduler has determined that a count of idle compute circuits is equal to or greater than this threshold number. The scheduler assigns work blocks to only the threshold number of idle compute circuits, which reduces the rate of work blocks being assigned and later issued. As a result of this decreased rate of assigning work blocks and activating compute circuits, between the times t3 and t4, the time rate of change of the current consumption from the power rail (di/dt) is lowered. Therefore, the resulting voltage droop is reduced between the times t3 and t4. In some implementations, between the times t3 and t4, the rate of assigning work blocks and activating compute circuits is zero, so no further idle compute circuits are activated. As a consequence, the rate di/dt becomes zero between the times t3 and t4.

It is noted that in some implementations, the scheduler updates over time the threshold number of idle compute circuits that can be simultaneously activated based on one or more of the number of pending work blocks, the number of activated compute circuits, the number of idle compute circuits, the queue utilizations of queues of the compute circuits that store assigned work blocks, an application identifier that indicates a type of work to be performed by activated compute circuits executing the work blocks, the power domain and/or P-state used by the activated compute circuits, and so on. At times t4 and t6, the waveform 320 indicates an increase in the rate of assigning work blocks and activating compute circuits similar to the increase at the time t2. At times t5 and t7, the waveform 320 indicates a decrease in the rate of assigning work blocks and activating compute circuits similar to the decrease at the time t3.

The waveform 320 illustrates that the rate of assigning work blocks and simultaneously activating compute circuits can be decreased to reduce voltage droop, but still maintain a high level of performance. For example, the time duration between a first point in time when the waveform 310 activates the maximum number of compute circuits between the times t4 and t5 and a second point in time when the waveform 320 activates the maximum number of compute circuits between the times t7 and t8 can be below a time threshold. It is also noted that the scheduler corresponding to the waveform 320 is proactively reducing the rate of assigning work blocks and simultaneously activating compute circuits based on values collected between the time intervals. For example, the decrease in the rate at time t3 is based on values collected prior to the time t3. Therefore, the scheduler is using a proactive method, rather than a reactive method. A reactive method includes on-die measurements of current consumption, and based on whether the measurement exceeds a threshold, limiting one or more of assigning work blocks at the scheduler or issuing instructions at the activated compute circuit. It is possible and contemplated that the integrated circuit is using the proactive method in combination with the reactive method to reduce voltage droop.

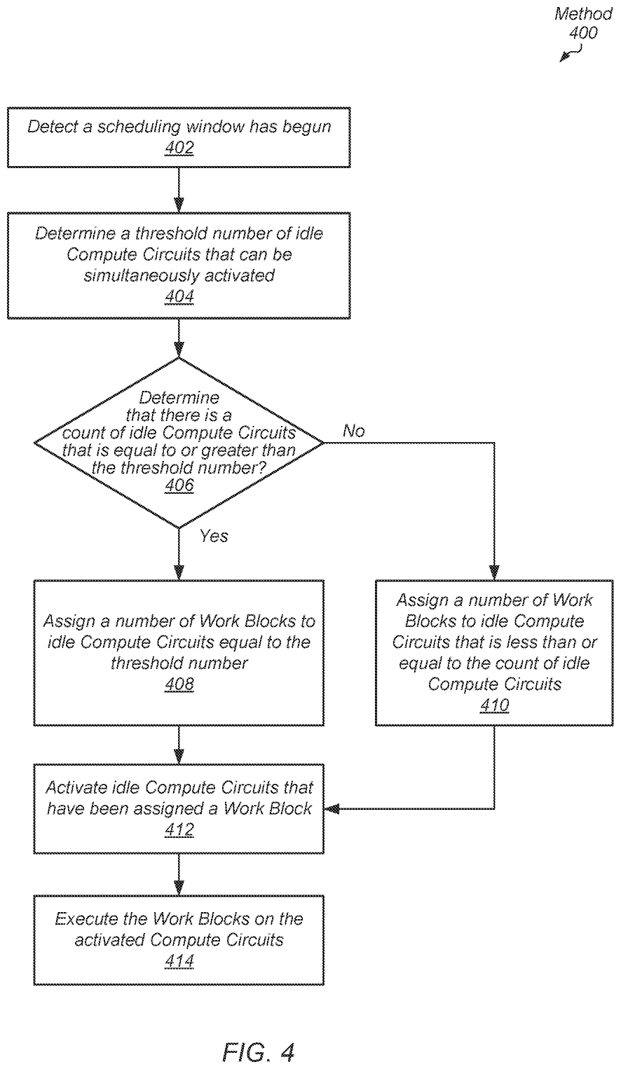

Referring now to FIG. 4, a generalized block diagram is shown of a method 400 for efficiently managing voltage droop of multiple compute circuits of an integrated circuit. For purposes of discussion, the steps in this implementation are shown in sequential order. However, in other implementations some steps occur in a different order than shown, some steps are performed concurrently, some steps are combined with other steps, and some steps are absent.

An integrated circuit includes multiple, replicated compute circuits. A scheduler assigns work blocks to idle compute circuits, which are subsequently activated and process the assigned work blocks. The scheduler detects a scheduling window has begun (block 402). For example, the scheduler determines that a particular time period has elapsed since a most recent assignment of work blocks has been performed. The scheduler determines a threshold number of idle compute circuits that can be simultaneously activated (block 404). In some implementations, the scheduler determines this threshold number of idle compute circuits based on one or more of a number of active compute circuits with assigned work blocks (or conversely, a number of idle compute units with no assigned work blocks), a total number of compute circuits, a number of stalled compute circuits, a number of compute circuits that have recently completed executing work blocks, a number of pending work blocks, any measured preexisting voltage droop, an operating clock frequency, a measured operating temperature, the queue utilizations of queues of the compute circuits that store assigned work blocks, and an application identifier.

In an implementation, the scheduler determines the threshold number of idle compute circuits that can be simultaneously activated based on a ratio of a number of idle compute circuits to a total number of compute circuits. To determine the number of idle compute circuits, the scheduler includes a number of compute circuits that have been previously assigned work blocks, but have not begun executing a corresponding work block. To determine the number of idle compute circuits, the scheduler also includes a number of compute circuits that have been executing work blocks, but have completed executing a corresponding work block. In some implementations, the scheduler reduces the threshold number of idle compute circuits that can be simultaneously activated when the scheduler receives an indication of a measurement of a preexisting non-zero voltage droop.

If the scheduler determines that there is a count of idle compute circuits that is equal to or greater than the threshold number of idle compute circuits (“yes” branch of the conditional block 406), then the scheduler assigns a number of work blocks to idle compute circuits equal to the threshold number (block 408). In other words, the scheduler limits the number of idle compute circuits that can be activated at one time to the threshold number. In various implementations, the scheduler limits the number of idle compute circuits that can be simultaneously activated even when the scheduler receives an indication of a power-performance state indicating that assigning one of the pending work blocks to each of the idle compute circuits should be done to maintain a particular throughput. In an example, the integrated circuit has 24 total compute circuits with 16 compute circuits being idle and 8 compute circuits being activated and already processing assigned work blocks. The circuitry of the scheduler is able to simultaneously assign 8 compute circuits in a clock cycle, but the threshold number is 4 for this particular clock cycle. As described earlier, the scheduler determines this threshold number of idle compute circuits based on one or more of a number of active compute circuits, a total number of compute circuits, a number of stalled compute circuits, a number of compute circuits that have recently completed executing work blocks, a number of pending work blocks, any measured preexisting voltage droop, an operating clock frequency, a measured operating temperature, the queue utilizations of queues of the compute circuits that store assigned work blocks, and an application identifier. Therefore, the scheduler assigns work blocks to only 4 idle compute circuits, rather than 8 idle compute circuits.

In some implementations, the scheduler changes the rate of scheduling. During a predetermined time period, the scheduler limits the total number of idle compute circuits that can be assigned work blocks and activated to process the assigned work blocks. In an implementation, the scheduler defines the time period as a particular number of clock cycles. The scheduler can determine to assign work blocks to idle compute circuits at a rate of 2 idle compute circuits every other clock cycle during the time period. At the end of the time period, the scheduler reevaluates scheduling based on updated parameters. For example, the scheduler redefines the threshold number of idle compute circuits based on updated values of the number of active compute circuits, the operating clock frequency, the measured operating temperature, the queue utilizations of queues of the compute circuits that store assigned work blocks, and any new application identifiers. The scheduler repeats the steps in blocks 402-406 of method 400.

If the scheduler determines that there is a count of idle compute circuits that is less than the threshold number of idle compute circuits (“no” branch of the conditional block 406), then the scheduler assigns a number of work blocks to idle compute circuits that is less than or equal to the count of idle compute circuits (block 410). If there are no data dependencies among the work blocks to be assigned and work blocks already being executed, then the scheduler assigns a number of work blocks to idle compute circuits that is equal to the count of idle compute circuits. Otherwise, the scheduler assigns a number of work blocks to idle compute circuits that is less than the count of idle compute circuits. The integrated circuit activates idle compute circuits that have been assigned a work block (block 412). The activated compute circuits execute the assigned work blocks (block 414).

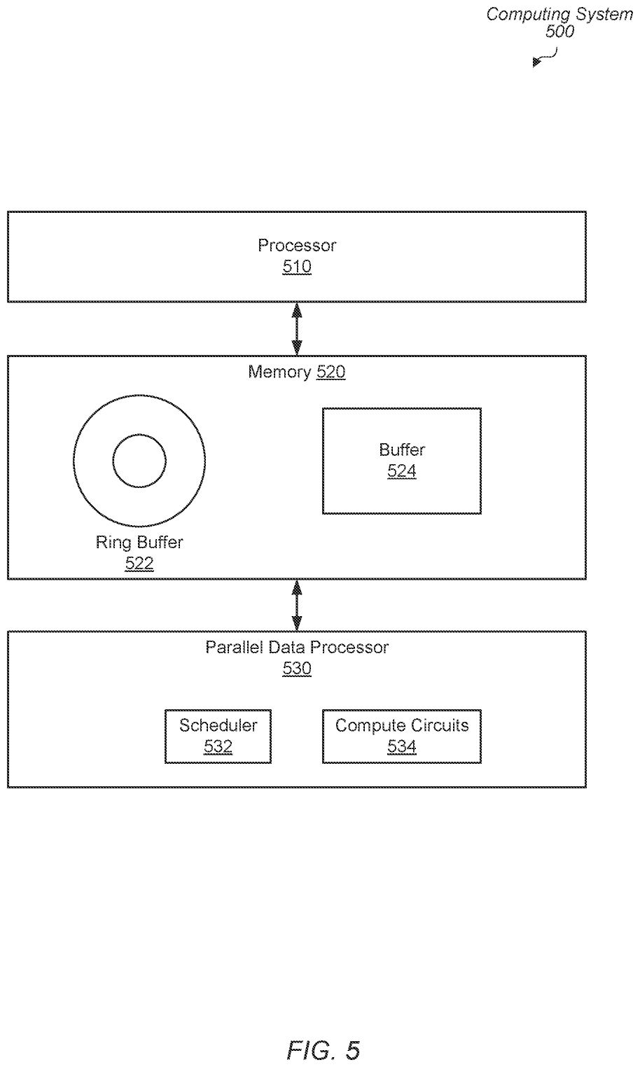

Turning now to FIG. 5, a generalized block diagram is shown of a computing system 500 that efficiently manages voltage droop of multiple compute circuits of an integrated circuit. As shown, the computing system 500 includes a processor 510, a memory 520 and a parallel data processor 530. In some implementations, the functionality of the computing system 500 is included as components on a single die, such as a single integrated circuit. In other implementations, the functionality of the computing system 500 is included as multiple dies on a system-on-a-chip (SOC). In other implementations, the functionality of the computing system 500 is implemented by multiple, separate dies that have been fabricated on separate silicon wafers and placed in system packaging known as multi-chip modules (MCMs). In various implementations, the computing system 500 is used in a desktop, a portable computer, a mobile device, a server, a peripheral device, or other.

The circuitry of the processor 510 processes instructions of a predetermined algorithm. The processing includes fetching instructions and data, decoding instructions, executing instructions, and storing results. In one implementation, the processor 510 uses one or more processor cores with circuitry for executing instructions according to a predefined general-purpose instruction set architecture (ISA). In various implementations, the processor 510 is a general-purpose central processing unit (CPU). The parallel data processor 530 uses one or more processor cores with a relatively wide single instruction multiple data (SIMD) micro-architecture to achieve high throughput in highly data parallel applications. In an implementation, the parallel data processor 530 is a graphics processing unit (GPU). In other implementations, the parallel data processor 530 is another type of circuitry.

In various implementations, the compute circuits 534 are SIMD circuits with the circuitry of multiple lanes of execution. The scheduler 532 schedules work blocks to the compute circuits 534 in a manner to reduce voltage droop of the compute circuits 534. In various implementations, the scheduler 532 includes the functionality of the scheduler 125 (or scheduler 127 or scheduler 142) (of FIG. 1), and performs the scheduling steps described to generate the waveform 320 of the graph 300 (of FIG. 3). Such functionality reduces a voltage droop such as the voltage droop 210 (of FIG. 2). The work blocks, here, are wavefronts (or waves) of multiple work items. The parallel data processor 530 is efficient for data parallel computing found within loops of applications, such as in applications for manipulating, rendering, and displaying computer graphics. In such cases, each of the data items of a wavefront is a pixel of an image. The applications can also include molecular dynamics simulations, finance computations, neural network training, and so forth. The highly parallel structure of the parallel data processor 530 makes it more effective than the general-purpose structure of the processor 510.

In various implementations, threads are scheduled on one of the processor 510 and the parallel data processor 530 in a manner that each thread has the highest instruction throughput based at least in part on the runtime hardware resources of the processor 510 and the parallel data processor 530. In some implementations, some threads are associated with general-purpose algorithms, which are scheduled on the processor 510, while other threads are associated with parallel data computationally intensive algorithms such as video graphics rendering algorithms, which are scheduled on the parallel data processor 530. The compute circuits 534 can be used for real-time data processing such as rendering multiple pixels, image blending, pixel shading, vertex shading, and geometry shading. Some threads, which are not video graphics rendering algorithms, still exhibit parallel data and intensive throughput. These threads have instructions which are capable of operating simultaneously with a relatively high number of different data elements (or data items). Examples of these threads are threads for scientific, medical, finance and encryption/decryption computations.

To change the scheduling of the above computations from the processor 510 to the parallel data processor 530, software development kits (SDKs) and application programming interfaces (APIs) were developed for use with widely available high-level languages to provide supported function calls. The function calls provide an abstraction layer of the parallel implementation details of the parallel data processor 530. The details are hardware specific to the parallel data processor 530 but hidden to the developer to allow for more flexible writing of software applications. The function calls in high level languages, such as C, C++, FORTRAN, and Java and so on, are translated to commands which are later processed by the hardware in the parallel data processor 530. Although a network interface is not shown, in some implementations, the parallel data processor 530 is used by remote programmers in a cloud computing environment.

A software application begins execution on the processor 510. Function calls within the application are translated to commands by a given API. The processor 510 sends the translated commands to the memory 520 for storage in the ring buffer 522. The commands are placed in groups referred to as command groups. In some implementations, the processors 510 and 530 use a producer-consumer relationship, which is also be referred to as a client-server relationship. The processor 510 writes commands into the ring buffer 522. Circuitry of a controller (not shown) of the parallel data processor 530 reads the commands from the ring buffer 522. In some implementations, the controller is a command processor of a GPU. The controller sends work blocks to the scheduler 532, which assigns work blocks to the compute circuits 534. By doing so, the parallel data processor 530 processes the commands, and writes result data to the buffer 524. The processor 510 is configured to update a write pointer for the ring buffer 522 and provide a size for each command group. The parallel data processor 530 updates a read pointer for the ring buffer 522 and indicates the entry in the ring buffer 522 at which the next read operation will use.

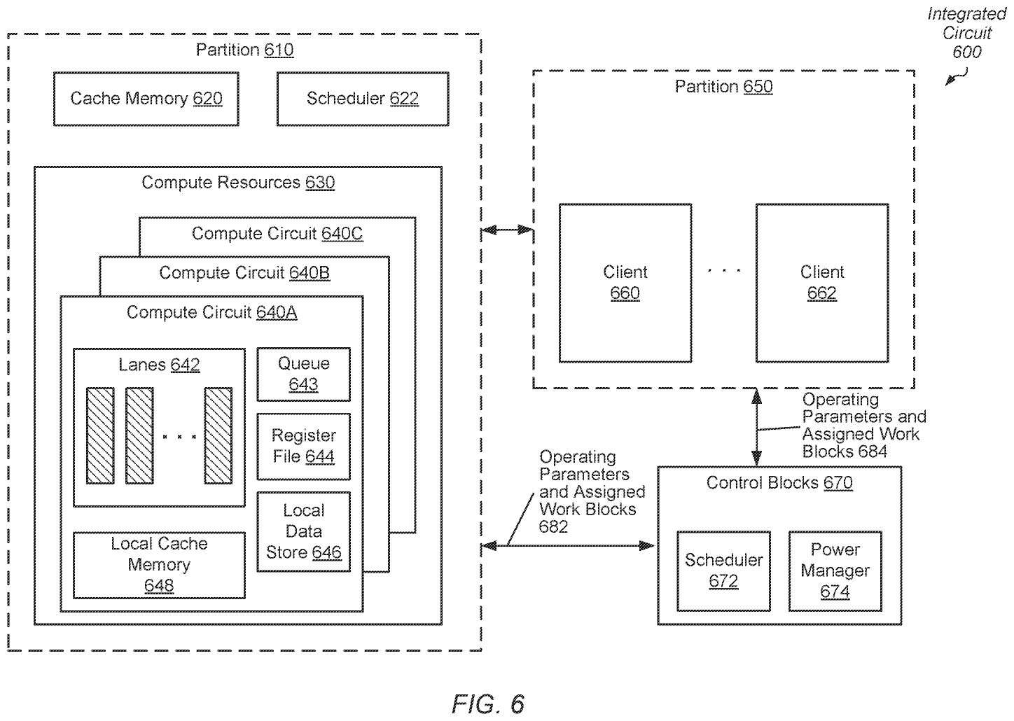

Referring to FIG. 6, a generalized block diagram is shown of an integrated circuit 600 that efficiently manages voltage droop of multiple compute circuits. In the illustrated implementation, the integrated circuit 600 that includes two partitions such as partition 610 and partition 650. Each of the partitions 610 and 650 includes components for processing work blocks. Partition 610 includes the cache memory 620 that is accessed by the compute resources 630. The compute resources 630 includes the compute circuits 640A, 640B and 640C (or compute circuits 640A-640C). Partition 650 includes the clients 660-662. The control blocks 670 includes the scheduler 672 and the power manager 674. In some implementations, the scheduler 672 and the power manager 674 have the same functionality of the scheduler 142 and the power manager 144 (of FIG. 1). For example, in an implementation, the scheduler 672 of the control blocks 670 schedules work blocks on the compute circuits 640A-640C of the partition 610. In other implementations, the scheduler 622 of the partition 610 schedules work blocks on the compute circuits 640A-640C. Either of the scheduler 672 and the scheduler 622 schedules work blocks on the compute circuits 640A-640C in a manner to reduce the voltage droop on the compute circuits 640A-640C. In various implementations, the scheduler 672 (or the scheduler 622) includes the functionality of the scheduler 125 (or scheduler 127 or scheduler 142 of FIG. 1), and performs the scheduling steps described to generate the waveform 320 of the graph 300 (of FIG. 3). Such functionality reduces a voltage droop such as the voltage droop 210 (of FIG. 2).

A communication fabric, a memory controller, interrupt controllers, and phased locked loops (PLLs) or other clock generating circuitry are not shown for ease of illustration. In some implementations, the functionality of the integrated circuit 600 is included as components on a single die such as a single integrated circuit. In an implementation, the functionality of the apparatus 100 is included as one die of multiple dies on a system-on-a-chip (SOC). In other implementations, the functionality of the integrated circuit 600 is implemented by multiple, separate dies that have been fabricated on separate silicon wafers and placed in system packaging known as multi-chip modules (MCMs). In various implementations, the apparatus 100 is used in a desktop, a portable computer, a mobile device, a server, a peripheral device, or other.

In some implementations, each of the partitions 610 and 650 is assigned to a respective power domain. In other implementations, each of the partitions 610 and 650 is assigned to a same power domain. A power domain includes at least operating parameters such as at least an operating power supply voltage and an operating clock frequency. A power domain also includes control signals for enabling and disabling connections to clock generating circuitry and one or more power supply references. In the information 682, the partition 610 receives operating parameters of a first power domain from power controller 670. In the information 684, the partition 650 receives operating parameters of a second power domain from the power controller 670.

The clients 660-662 include a variety of types of circuits such as a central processing unit (CPU), a digital signal processor (DSP), an application specific integrated circuit (ASIC), a field programmable gate array (FPGA), a multimedia engine, and so forth. Each of the clients 660-662 is capable of processing work blocks of a variety of workloads. In some implementations, work blocks scheduled on the partition 610 include wavefronts, whereas, work blocks scheduled on the partition 650 include instructions operating on a single data item and not grouped into wavefronts. Additionally, each of the clients 660-662 is capable of generating and servicing one or more of a variety of requests such as memory access read and write requests and cache snoop requests.

In one implementation, the integrated circuit 600 is a graphics processing unit (GPU). The circuitry of the compute resources 630 of partition 610 process highly data parallel applications. The compute resources 630 include the multiple compute circuits 640A-640C, each with multiple lanes 642. In some implementations, the lanes 642 operate in lockstep. In various implementations, the data flow within each of the lanes 642 is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the computational circuits within a given row across the lanes 642 is the same computational circuit. Each of these computational circuits operates on a same instruction, but different data associated with a different thread. As described earlier, a number of work items are grouped into a wavefront for simultaneous execution by multiple SIMD execution lanes such as the lanes 642 of the compute circuits 640A-640C. Each data item is processed independently of other data items, but the same sequence of operations of the subroutine is used.

As shown, each of the compute circuits 640A-640C also includes a respective queue 643 for storing assigned work blocks, register file 644, a local data store 646, and a local cache memory 648. In some implementations, the local data store 646 is shared among the lanes 642 within each of the compute circuits 640A-640C. In other implementations, a local data store is shared among the compute circuits 640A-640C. Therefore, it is possible for one or more of lanes 642 within the compute circuit 640A to share result data with one or more lanes 642 within the compute circuit 640A based on an operating mode. In an implementation, the queue 643 is implemented as first-in, first-out (FIFO) buffer. Each queue entry of the queue 643 is capable of storing an assigned work block received from the scheduler 622 (or the scheduler 672). Each queue entry can also be referred to as a “slot.” A slot stores program state of the assigned work block. In various implementations, the compute circuits 640A-640C maintain a count of available slots, or queue entries, in the queues that store assigned work blocks. The compute circuits 640A-640C send this count as information to the scheduler 622 (or the scheduler 672). Although an example of a single instruction multiple data (SIMD) micro-architecture is shown for the compute resources 630, other types of highly parallel data micro-architectures are possible and contemplated. The high parallelism offered by the hardware of the compute resources 630 is used for simultaneously rendering multiple pixels, but it is also capable of simultaneously processing the multiple data elements of the scientific, medical, finance, encryption/decryption, and other computations.

The clients 660-662 can also include one or more of an analog-to-digital converter (ADC), a scan converter, a video decoder, a display controller, and other compute circuits. In some implementations, the partition 660 is used for real-time data processing, whereas the partition 650 is used for non-real-time data processing. Examples of the real-time data processing are rendering multiple pixels, image blending, pixel shading, vertex shading, and geometry shading. Examples of the non-real-time data processing are multimedia playback, such as a video decoding for encoded audio/video streams, image scaling, image rotating, color space conversion, power up initialization, background processes such as garbage collection, and so forth. Circuitry of a controller (not shown) receives tasks. In some implementations, the controller is a command processor of a GPU, and the task is a sequence of commands (instructions) of a function call of an application. The controller assigns a task to one of the two partitions 610 and 650 based on a task type of the received task. One of the schedulers 672 and 622 receives these tasks from the controller, organizes the tasks as work blocks, if not already done so, and schedules the work blocks on the compute circuits 640A-640C in a manner to reduce the voltage droop on the compute circuits 640A-640C.

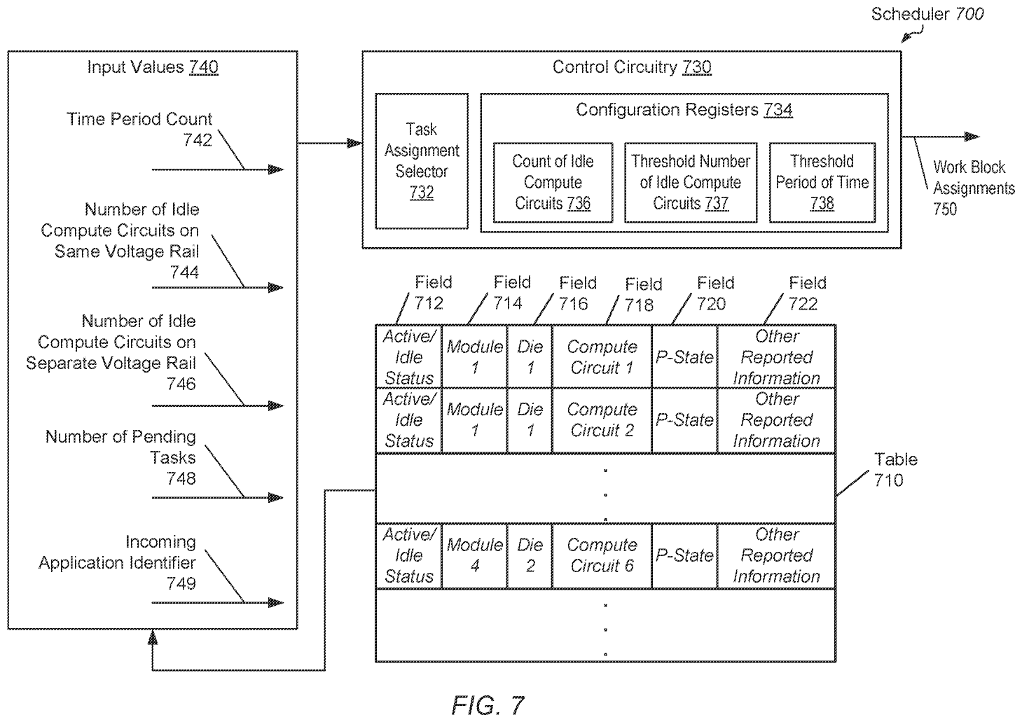

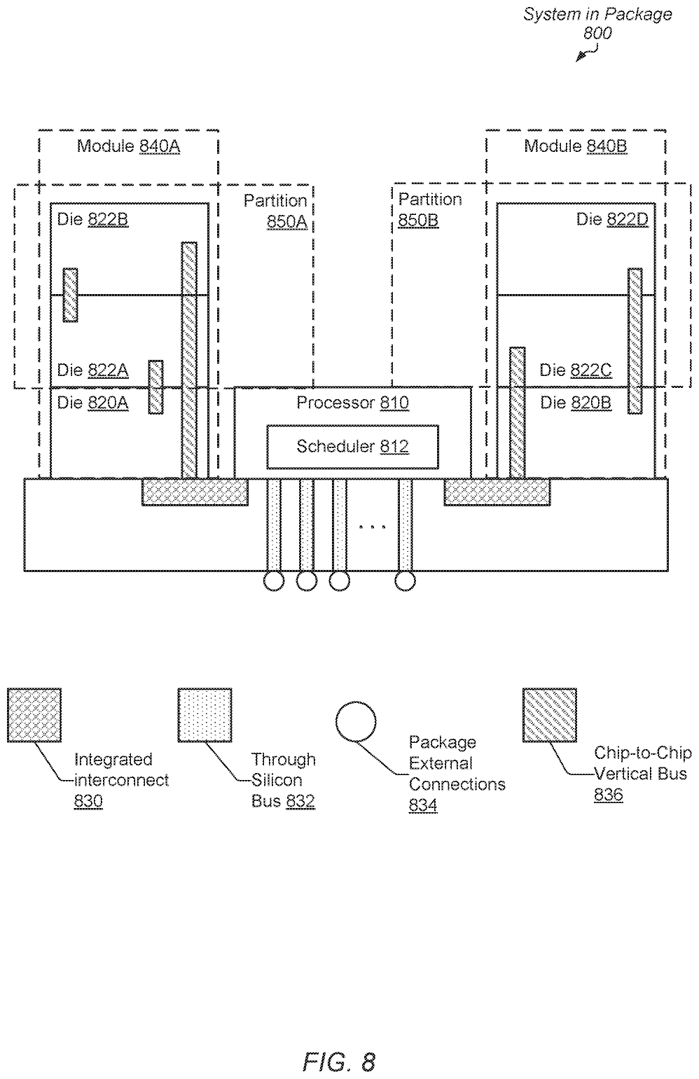

Turning now to FIG. 7, a generalized block diagram is shown of a scheduler 700 that manages voltage droop among replicated compute circuits of an integrated circuit. As shown, the scheduler 700 includes the table 710 and the control circuitry 730. The control circuitry 730 receives the input values 740 and generates the work block assignments 750 for multiple, replicated compute circuits of the integrated circuit. The control circuitry 730 generates the work assignments 750 in a manner to reduce the voltage droop of one or more power rails used by multiple, replicated compute circuits. The control circuitry 730 includes the components 732-738 that are used to assign work blocks to multiple, replicated compute circuits. In some implementations, a compute circuit is a single instruction multiple data (SIMD) circuit that includes multiple lanes of execution, and a work block is a wavefront that includes multiple work items. The table 710 includes multiple table entries (or entries), each storing information in multiple fields such as at least fields 712-722. In some implementations, one or more of the components of scheduler 700 and corresponding functionality is provided in another external circuit, rather than provided here in scheduler 700. In various implementations, the functionality provided by the scheduler 700 is also provided in the scheduler 125 (or scheduler 127 or scheduler 142) (of FIG. 1), the scheduler 532 (of FIG. 5), the scheduler 672 (or scheduler 622) (of FIG. 6), and the scheduler 812 (of FIG. 8).

The table 710 is implemented with one of flip-flop circuits, a random-access memory (RAM), a content addressable memory (CAM), or other. Although particular information is shown as being stored in the fields 712-722 and in a particular contiguous order, in other implementations, a different order is used and a different number and type of information is stored. The field 712 stores status information such as at least a valid bit and an indication of a corresponding compute circuit being active or idle. An active compute circuit processes an assigned work block using operating parameters of an assigned P-state. An idle compute circuit has no assigned work block, and typically is clock gated, or otherwise, the idle compute circuit has connections to clock generating circuitry disabled. Field 714 stores an identifier that specifies one of the multiple, replicated modules of the integrated circuit. Field 716 stores an identifier that specifies one of the multiple dies within a particular module. Field 718 stores an identifier that specifies one of the multiple compute circuits within a particular die.

The field 720 stores operating parameters of a particular power-performance state (P-state) currently used by the corresponding compute circuit such as at least an operating power supply voltage and an operating clock frequency. In an implementation, one or more of the operating power supply voltage and the operating clock frequency are used by the control circuitry 730 to generate the work block assignments 750. The field 722 stores other reported information such as an application identifier specifying a type of application (and thus, the type of work block) being processed by a corresponding compute circuit. The type of application can provide an indication of an activity level or power consumption required to process work blocks of the application. Another example of the information in field 722 is whether a first work block of a corresponding compute circuit is data dependent on a second work block, and therefore, both the first and second work blocks should be assigned to the corresponding compute circuit. The field 722 can also store an indication of a power rail in cases where some of the compute circuits of the integrated circuit do not use a same power rail as other compute circuits.

The control circuitry 730 receives the input values 740, which are used with values stored in the table 710 and the configuration registers 734 to generate the work block assignments 750. Although a particular number and type of input values are shown, in other implementations, another number and type of input values are used by the control circuitry 730. The input values 740 includes the time period count 742, which is a timer output value that counts a number of clock cycles since a last time that the control circuitry 730 generated the work block assignments 750. In another implementation, the configuration registers 734 include a timer that maintains this count value. The control circuitry 730 compares the time period count 742 to the threshold period of time 738, and when a match occurs, the work block assignment selector 732 generates the work block assignments 750 using values stored in the table 710 and the configuration registers 734. In various implementations, a match occurs when the threshold period of time 738 has elapsed since a most recent assignment of work blocks to idle compute circuits 750 has occurred.

In an implementation, the time period count 742 is a count of clock cycles. In an implementation, one or more of external circuitry and the control circuitry 730 resets the time period count 742 when the control circuitry has generated the work block assignments 750. In an implementation, the time period indicated by the threshold period of time 738 is less than a duration of time for a compute circuit to complete execution of an assigned work block. In other implementations, the time period indicated by the threshold period of time 738 is greater than the duration of time for a compute circuit to complete execution of an assigned work block. In some implementations, the control circuitry 730 maintains multiple values for the threshold period of time 738, and selects a particular value based on one or more of the input values 740 and values stored in the table 710. For example, a value of the threshold period of time 738 for high-performance and high-power consumption applications running on compute circuits using operating parameters of a high-performance P-state can be different from a value of the threshold period of time 738 for lower performance and lower power consumption applications running on compute circuits using operating parameters of a lower performance P-state.

In some implementations, the control circuitry 730 determines the count of idle compute circuits on a same voltage rail 744 and the number of idle compute circuits on a separate voltage rail 746 from the table 710. In some implementation, the number (count) of idle compute circuits on the same voltage rail 744 is based on the control circuitry 730 receiving queue utilizations of queues of the compute circuits that store assigned work blocks. In other implementations, when a compute circuit becomes idle, one or more of the configuration registers 734, such as the count of compute circuits 734 and the table 710 are updated, and one or more of the input values 744 and 746 are adjusted. When the available compute circuits use two or more power supply reference level rails (or power rails) that are enabled (power switches connect the power rails to the compute circuits), the scheduler 700 can assign work blocks among available compute circuits across different power rails. Distributing the assignment of work blocks in this manner helps reduce voltage droop on any one power rail. In such cases, the configuration registers 734 can include a separate set of registers for the values 736-738 for each of the power rails.

When each of the available compute circuits uses a single, shared voltage rail, the input value 746 is not used. In such a case, the configuration registers 734 includes a single set of registers for the values 736-738 for the single available power rail. In an implementation, the number of pending work blocks 748 is provided by external circuitry. In another implementation, the control circuitry 730 determines the input value 748 from the one or more applications being processed. The incoming application identifier 749 specifies a type of application (and thus, the type of work block) to be processed by one or more compute circuits. The type of application can provide an indication of an activity level or power consumption required to process work blocks of the incoming application.

In some implementations, the control circuitry 730 also receives an indication of an operating temperature. In such an implementation, the integrated circuit provides a measured temperature value derived from measurements of analog and/or digital thermal sensors placed throughout the integrated circuit. When it is determined that the time period count 742 indicates a next assignment of work blocks is to be performed, such as matching the threshold period of time 738, the hardware of the work block assignment selector 732 (or selector 732) generates the work block assignments 750 based on at least the input values 740 and values stored in table 710. Rather than assign work blocks to a maximum number of available, idle compute circuits to maximize performance, the selector 732 assigns work blocks to a smaller number of available, idle compute circuits. This smaller number is based on reducing the voltage droop of a power supply rail used by the multiple compute circuits. This smaller number is represented by the threshold number of idle compute circuits 737 of the configuration registers 734.

In some implementations, the threshold number of idle compute circuits 737 is based on one or more of the input values 740 and values stored in the table 710, and this number was determined during testing and characterization of the integrated circuit. Each of these threshold numbers of idle compute circuits provides a voltage droop of a corresponding power supply reference level used by multiple compute circuits that is less than a voltage threshold. Therefore, one or more threshold numbers of idle compute circuits to simultaneously activate at a particular time are stored in one or more of a table (separate from the table 710), another data structure, a memory storing firmware, and a ROM (or EPROM). The selector 732 generates an index based on one or more of the input values 740 and values stored in the table 710, and then indexes into the table or other data structure using the generated index and retrieves a threshold number of idle compute circuits to activate. The selector 732 stores this retrieved value in the configuration registers 734 in a programmable register of the configuration registers 734 as the threshold number of idle compute circuits 737. In another implementation, the control circuitry 700 stores a data structure locally that includes multiple values for the threshold number of idle compute circuits 737, and retrieves a value to use for assignments based on conditions satisfied by one or more of the input values 740 and values stored in the table 710.

In some implementations, the control circuitry 730 maintains a count of idle compute circuits 736 of multiple compute circuits in the configuration registers 734 that share a power supply reference level rail (a power rail). To maintain this count 736, the selector 732 uses the table 710 and any received updates of the active/idle status information used to update the table 710. When the selector 732 determines that the time period count 742 matches (or no longer less than) the threshold period of time 738, the selector 732 ensures that a number of idle compute circuits to assign work blocks and activate does not exceed the threshold number of idle compute circuits 737. For example, when the selector 732 determines that the time period count 742 matches (or is no longer less than) the threshold period of time 738, and the selector 732 determines that the count of idle compute circuits 734 is equal to or greater than the threshold number of idle compute circuits 737, the selector assigns the threshold number of work blocks to a number of idle compute circuits less than or equal to the threshold number of idle compute circuits 737. The scheduler 700 or other external circuitry activates the assigned idle compute circuits, and provides these compute circuits with the assigned work blocks for processing. When a first work block of a corresponding compute circuit is data dependent on a second work block, and therefore, both the first and second work blocks should be assigned to the corresponding compute circuit, it is possible that the selector 732 assigns a number of idle compute circuits that is less than the threshold number of idle compute circuits 737.

In an example, an integrated circuit includes 12 compute circuits, and the count of idle compute circuits on a same voltage rail 744 is 9 idle compute circuits. Based on operating conditions determined from the input values 740 and values stored in the table 710, the control circuitry 730 determines that the threshold number of idle compute circuits 737 is 6 idle compute circuits. The number of pending work blocks 748 is 18. When the selector 732 determines that the time period count 742 matches (or is no longer less than) the threshold period of time 738, and the selector 732 determines that the count of idle compute circuits 734 (9 compute circuits) is equal to or greater than the threshold number of idle compute circuits 737 (6 compute circuits), the selector assigns work blocks to idle compute circuits. However, rather than assign the maximum number of 9 idle compute circuits to 9 work blocks, the scheduler 700 assigns the threshold number of idle compute circuits 737 of 6 idle compute circuits to 6 work blocks. Therefore, the scheduler 700 reduces the voltage droop on the power rail shared by the idle compute circuits. For example, the scheduler 700 provides a voltage droop of the power rail used by the 12 compute circuits that is less than a voltage threshold.

It is possible that data dependencies between work blocks cause the scheduler 700 to assign only 4 or 5 work blocks to 4 or 5 idle compute circuits, which is less than the threshold number of idle compute circuits 737 of 6 idle compute circuits and the maximum number of 9 idle compute circuits. When the number of pending work blocks 748 is 5, which is less than the threshold number of idle compute circuits 737 of 6 idle compute circuits, the scheduler 700 is able to assign all 5 of the pending work blocks to 5 idle compute circuits when data dependencies do not reduce the number of assigned idle compute circuits. In some implementations, the integrated circuit is a graphics processing unit (GPU) or another parallel data processing circuit.

In an example, the integrated circuit includes 8 chiplets, each chiplet includes 6 compute circuits, each compute circuit includes 2 SIMD circuits, and each SIMD circuit includes 64 lanes of execution to simultaneously execute 64 work items. Therefore, the integrated circuit is capable of simultaneously executing 6,144 work items in 6,144 lanes of execution, since there are 6,144 available lanes of execution (64×2×6×8=6,144). A wavefront (or wave) is 64 work items, and the scheduler 700 considers a wavefront as a work block. Therefore, in this example, the scheduler 700 considers a SIMD circuit as a compute circuit, and there is a maximum of 96 work blocks for simultaneous execution on 96 compute circuits, since there are 96 compute circuits (2×6×8=96). For the table 710, the scheduler 700 also considers the chiplet as a die, and considers the compute circuit as a module. The values 736-738 stored in the configuration registers 734 for this example are updated based on one or more of the input values 740 and values stored in the table 710.

Turning now to FIG. 8, a generalized block diagram is shown of a system-in-package (SiP) 800 that manages voltage droop of multiple compute circuits of an integrated circuit. In various implementations, three-dimensional (3D) packaging is used within a computing system. This type of packaging is referred to as a System in Package (SiP). A SiP includes one or more three-dimensional integrated circuits (3D ICs). A 3D IC includes two or more layers of active electronic components integrated both vertically and/or horizontally into a single circuit. In one implementation, interposer-based integration is used whereby the 3D IC is placed next to the processor 810. Alternatively, a 3D IC is stacked directly on top of another IC.

Die-stacking technology is a fabrication process that enables the physical stacking of multiple separate pieces of silicon (integrated chips) together in a same package with high-bandwidth and low-latency interconnects. In some implementations, the die is stacked side by side on a silicon interposer, or vertically directly on top of each other. One configuration for the SiP is to stack one or more semiconductor dies (or dies) next to and/or on top of a processor such as processor 810. In an implementation, the SiP 800 includes the processor 810 and the modules 840A-840B. Module 840A includes the semiconductor die 820A and the multiple three-dimensional (3D) semiconductor dies 822A-822B within the partition 850A. Although two dies are shown, any number of dies is used as stacked 3D dies in other implementations.

In a similar manner, the module 840B includes the semiconductor die 820B and the multiple 3D semiconductor dies 822C-822D within the partition 850B. Although not shown, each of the dies 822A-822B and dies 822C-822D include one or more compute circuits. The scheduler 812 schedules work blocks on the compute circuits within the dies 822A-822B and 822C-822D in a manner to reduce the voltage droop on the compute circuits. In various implementations, the scheduler 812 includes the functionality of the scheduler 125 (or scheduler 127 or scheduler 142) (of FIG. 1), the scheduler 532 (of FIG. 5), the scheduler 672 (or scheduler 622) (of FIG. 6), and the scheduler 700 (of FIG. 7). The scheduler 812 performs the scheduling steps described to generate the waveform 320 of the graph 300 (of FIG. 3). Such functionality reduces a voltage droop such as the voltage droop 210 (of FIG. 2).

The dies 822A-822B within the partition 850A share at least a same power rail. The dies 822A-822B can also share a same clock signal. The dies 822C-822D within the partition 850B share at least a same power rail. The dies 822C-822D can also share a same clock signal. In some implementations, another module is placed adjacent to the left of module 840A that includes a die that is an instantiated copy of the die 820A. It is possible and contemplated that this other die and die 820A share at least a power rail.

Each of the modules 840A-840B communicates with the processor 810 through horizontal low-latency interconnect 830. In various implementations, the processor 810 is a general-purpose central processing unit (CPU); a graphics processing unit (GPU), an accelerated processing unit (APU), a field programmable gate array (FPGA), or other data processing device. The in-package horizontal low-latency interconnect 830 provides reduced lengths of interconnect signals versus long off-chip interconnects when a SiP is not used. The in-package horizontal low-latency interconnect 830 uses particular signals and protocols as if the chips, such as the processor 810 and the modules 840A-840B, were mounted in separate packages on a circuit board. In some implementations, the SiP 800 additionally includes backside vias or through-bulk silicon vias 832 that reach to package external connections 834. The package external connections 834 are used for input/output (I/O) signals and power signals.

In various implementations, multiple device layers are stacked on top of one another with direct vertical interconnects 836 tunneling through them. In various implementations, the vertical interconnects 836 are multiple through silicon vias grouped together to form through silicon buses (TSBs). The TSBs are used as a vertical electrical connection traversing through a silicon wafer. The TSBs are an alternative interconnect to wire-bond and flip chips. The size and density of the vertical interconnects 836 that can tunnel between the different device layers varies based on the underlying technology used to fabricate the 3D ICs.

As shown, some of the vertical interconnects 836 do not traverse through each of the modules 840A-840B. Therefore, in some implementations, the processor 810 does not have a direct connection to one or more dies such as die 822D in the illustrated implementation. Therefore, the routing of information relies on the other dies of the SiP 800. In various implementations, the dies 822A-822B and 822C-822D are chiplets. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM.

On a single silicon wafer, only multiple chiplets are fabricated as multiple instantiated copies of particular integrated circuitry, rather than fabricated with other compute circuits that do not use an instantiated copy of the particular integrated circuitry. For example, the chiplets are not fabricated on a silicon wafer with various other compute circuits on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet.

A second silicon wafer (or second wafer) is fabricated with multiple instantiated copies of integrated circuitry of a second chiplet, and this second wafer is diced using laser cutting techniques to separate the multiple copies of the second chiplet. The first chiplet provides functionality different from the functionality of the second chiplet. One or more copies of the first chiplet is placed in an integrated circuit, and one or more copies of the second chiplet is placed in the integrated circuit. The first chiplet and the second chiplet are interconnected to one another within a corresponding MCM. Such a process replaces a process that fabricates a third silicon wafer (or third wafer) with multiple copies of a single, monolithic semiconductor die that includes the functionality of the first chiplet and the second chiplet as integrated compute circuits within the single, monolithic semiconductor die.

Process yield of single, monolithic dies on a silicon wafer is lower than process yield of smaller chiplets on a separate silicon wafer. In addition, a semiconductor process can be adapted for the particular type of chiplet being fabricated. With single, monolithic dies, each die on the wafer is formed with the same fabrication process. However, it is possible that an interface compute circuit does not require process parameters of a semiconductor manufacturer's expensive process that provides the fastest devices and smallest geometric dimensions that are beneficial for a high throughput circuitry on the die. With separate chiplets, designers can add or remove chiplets for particular integrated circuits to readily create products for a variety of performance categories. In contrast, an entire new silicon wafer must be fabricated for a different product when single, monolithic dies are used. It is possible and contemplated that the dies 122A-122D (of FIG. 1), and the compute resources 630 or the partition 610 (of FIG. 6) are implemented as chiplets as well.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a plurality of compute circuits, each comprising circuitry configured to process a work block; and
circuitry configured to:
receive one or more work blocks for assignment to one or more compute circuits of the plurality of compute circuits;
determine a threshold number of idle compute circuits permitted to be simultaneously activated; and
assign a number of the one or more work blocks that is no more than the threshold number to idle compute circuits.

2. The apparatus as recited in claim 1, wherein the circuitry is further configured to determine the threshold number of idle compute circuits permitted to be simultaneously activated based on a comparison of the number of idle compute circuits to a number of the plurality of compute circuits.

3. The apparatus as recited in claim 2, wherein the circuitry is further configured to:
receive an indication of a number of compute circuits that have not begun execution of a previously assigned work block; and
determine the threshold number of idle compute circuits permitted to be simultaneously activated based at least in part on the indication.

4. The apparatus as recited in claim 2, wherein the circuitry is further configured to:
receive an indication of a number of compute circuits that have completed execution of a work block; and
determine the threshold number of idle compute circuits permitted to be simultaneously activated based at least in part on the indication.

5. The apparatus as recited in claim 1, wherein the circuitry is further configured to reduce the threshold number of idle compute circuits that can be simultaneously activated, in response to receiving an indication of a non-zero voltage droop measurement.

6. The apparatus as recited in claim 1, wherein the circuitry is further configured to compare the threshold number of idle compute circuits that can be simultaneously activated to the number of idle compute circuits, in response to expiration of a period of time since a most recent scheduling window.

7. The apparatus as recited in claim 1, wherein:
each of the plurality of compute circuits is a single instruction multiple data (SIMD) circuit comprising a plurality of lanes of execution; and
each work block is a wavefront comprising a plurality of work items.

8. A method, comprising:
processing work blocks by circuitry of a plurality of compute circuits;
receiving, by circuitry of a scheduler, one or more work blocks for assignment to one or more compute circuits of the plurality of compute circuits;
determining, by the scheduler, a threshold number of idle compute circuits permitted to be simultaneously activated; and
assigning, by the scheduler, a number of the one or more work blocks that is no more than the threshold number to idle compute circuits.

9. The method as recited in claim 8, further comprising determining, by the scheduler, the threshold number of idle compute circuits permitted to be simultaneously activated based on a comparison of the number of idle compute circuits to a number of the plurality of compute circuits.

10. The method as recited in claim 9, further comprising:
receiving, by the scheduler, an indication of a number of compute circuits that have not begun execution of a previously assigned work block; and
determining, by the scheduler, the threshold number of idle compute circuits permitted to be simultaneously activated based at least in part on the indication.

11. The method as recited in claim 9, further comprising:
receiving, by the scheduler, an indication of a number of compute circuits that have completed execution of a work block; and
determining, by the scheduler, the threshold number of idle compute circuits permitted to be simultaneously activated based at least in part on the indication.

12. The method as recited in claim 8, further comprising reducing, by the scheduler, the threshold number of idle compute circuits that can be simultaneously activated, in response to receiving an indication of a non-zero voltage droop measurement.

13. The method as recited in claim 8, further comprising comparing, by the scheduler, the threshold number of idle compute circuits that can be simultaneously activated to the number of idle compute circuits, in response to expiration of a period of time since a most recent scheduling window.

14. The method as recited in claim 8, wherein:
each of the plurality of compute circuits is a single instruction multiple data (SIMD) circuit comprising a plurality of lanes of execution; and
each work block is a wavefront comprising a plurality of work items.

15. A computing system comprising:
a processor;
a plurality of chiplets, each comprising one or more compute circuits comprising circuitry configured to process a work block; and
a scheduler comprising circuitry configured to:
receive one or more work blocks for assignment to one or more compute circuits of the plurality of chiplets;
determine a threshold number of idle compute circuits permitted to be simultaneously activated; and
assign a number of the one or more work blocks that is no more than the threshold number to idle compute circuits.

16. The computing system as recited in claim 15, wherein the scheduler is further configured to determine the threshold number of idle compute circuits permitted to be simultaneously activated based on a comparison of the number of idle compute circuits to a number of the plurality of chiplets.

17. The computing system as recited in claim 16, wherein the scheduler is further configured to:
receive an indication of a number of compute circuits that have not begun execution of a previously assigned work block; and
determine the threshold number of idle compute circuits permitted to be simultaneously activated based at least in part on the indication.

18. The computing system as recited in claim 16, wherein the scheduler is further configured to:
receive an indication of a number of compute circuits that have completed execution of a work block; and
determine the threshold number of idle compute circuits permitted to be simultaneously activated based at least in part on the indication.

19. The computing system as recited in claim 15, wherein the scheduler is further configured to reduce the threshold number of idle compute circuits that can be simultaneously activated, in response to receiving an indication of a non-zero voltage droop measurement.

20. The computing system as recited in claim 15, wherein the scheduler is further configured to compare the threshold number of idle compute circuits that can be simultaneously activated to the number of idle compute circuits, in response to expiration of a period of time since a most recent scheduling window.
